(19) United States
(12) Patent Application Publication
(10) Pub. No.: US 2015/0352797 A1
(43) Pub. Date: Dec. 10, 2015

(54) 3D printed objects and printing methods that controls light reflection direction and strength

(71) Applicant: Yasusi Kanada, Tokyo (JP)

(72) Inventor: Yasusi Kanada, Tokyo (JP)

(21) Appl. No.: 14/726,647

(22) Filed: Jun. 1, 2015

(30) Foreign Application Priority Data
Jun. 6, 2014 (JP) 2014-118200

(51) Int. Cl. B29D 11/00; D01F 6/62; B29C 47/00

(52) U.S. Cl. CPC B29D 11/0073; B29C 47/0009; D01F 6/625; B29L 2011/0083

(57) ABSTRACT

The purpose of this invention is to enable forming 3D objects by a 3D printer with controlling the strength and the direction of the light reflection and to enable forming 3D-printed objects with brilliant reflections of various directions.

To solve the problem above, one of the following means are to be used for varying the direction or strength of reflection by controlling the motion mechanism of the print head or the extruder that extrudes filament. First, the intervals of neighboring filaments are varied location to location. Second, the cross sections of filaments are varied location to location. Third, the angle of neighboring filaments is varied location to location.

### BACKGROUND OF THE INVENTION

A basic technology of 3D printers of so-called fused-deposition-modeling type, which use ABS resin or PLA resin filament, are described in the U.S. Pat. No. 5,136,515 by Richard Helinski. In addition, there are other types of 3D printers that use materials which are gel state in room temperature but becomes solid by heat or light. By using such technologies, object models to be printed are sliced to thin layers, and each layer is formed by arraying filament in horizontal directions, and the layers are stacked. Therefore, the filament direction can be observed normally on the printed object. In a sparsely-printed object, the shapes of filaments immediately after extrusion is preserved so the filament direction can be observed; however, in a densely-printed object, filaments are bonded to neighbor filaments and only limited traces of filaments can be observed. However, because the printing direction is strictly horizontal, the direction of filaments and the lines are limited to horizontal directions. In addition, the material of filament, such as ABS, which easily causes diffused reflection, are usually used, and brightness is not taken into account in design or production.

### BRIEF SUMMARY OF THE INVENTION

### Problems to be Solved by this Invention

Materials used for fused-deposition-modeling (FDM) type printers or other layering 3D printers include resin such as PLA, which reflects light and causes brilliance on the printed filament surface. That is, light is reflected on the surface of the printed filaments to specific directions. This means that brilliant light can be observed when using a (specific type of) transparent filament and selecting an appropriate lighting direction. However, because the strength and direction of brilliance cannot be controlled by conventional 3D printing method, this effect is limited. The problem to be solved by this invention is that developing a 3D printing method that can control the strength and direction of reflection, so that producing 3D-printed objects which have brilliance of various directions.

### Means to Solve the Problems

To solve the above problem, the parameters for 3D printing are selected so that the interval between neighboring filaments, the cross section of filament, or the angle of neighboring filaments is different from location to location, and thus the strength of reflection is different from location to location. This means that the mechanisms of the print-head and the extruder that extrudes melted filament are controlled to vary the distance between neighboring extruded filaments, to vary the cross section of the filament by controlling the printing velocity and/or filament extrusion velocity, and prints and forms the object with varying the light reflection direction or reflection strength.

### The Effect of this Invention

This invention enables 3D printing that the direction and the strength of light reflection of printed objects can be controlled, and enables producing 3D printed objects that reflect light to various directions at various strength.

### BRIEF DESCRIPTION OF DRAWINGS

FIG. 1 explains the method for reflecting light and the method for suppressing diffusion of reflected light in the embodiment of this invention.

FIG. 2 explains the method of controlling the direction of light reflection by controlling the intervals of neighboring filaments in the embodiment of this invention.

FIG. 3 explains the method of controlling the direction of light reflection by controlling the cross section of filaments in the embodiment of this invention.

FIG. 4 explains the method of controlling the direction of light reflection by the angle between neighboring filaments in the embodiment of this invention.

FIG. 5 explains the conditions to preserve 3D-printability and the method of preserving 3D-printability in the embodiment of this invention.

FIG. 6 explains the method for bonding filaments when the direction of the filament array is close to horizontal and the angle between the centers of the filaments are non-negative in the embodiment of this invention.

FIG. 7 explains the method of preserving 3D-printability when rotating the print head in the embodiment of this invention.

FIG. 8 explains the method of printing bottom surface with brilliance in the embodiment of this invention.

### DETAILED DESCRIPTION OF THE INVENTION

### Embodiment

### Outline of 3D-Printing Method

In conventional methods of 3D-printing that layer filaments and form shapes, a 3D printer extrudes melted filament from the nozzle of the print-head immediately over a print bed, previously extruded filament, or support material (which means material only for supporting filament and is removed after printing). To move the print head, a 3D printer usually has three stepping motors that control motions towards x, y, and z directions, or has three stepping motors that control a parallel-link mechanism. The motions of these motors are propagated to the print head by gears or belts. In addition, to extrude filament, a pinch roller pinches the filament and the roller is driven by a stepping motor. The motion speeds of the print head and the filament are electronically controlled by the control system of the stepping motors.

In 3D printing, a supporter (i.e., the print bed, solidified filament, or support material) is usually underneath the extruded melted filament. However, by using certain method and conditions, it is possible to print correctly even when a supporter is in a skewed downward direction, that means, in an overhung state. Thus, a shape such as a dish, can be printed.

### [Method of Controlling Reflected Light]

Depending on material of filament, the surface of printed filament may have asperity and it diffuses light (makes difficult to reflect light); however, by using material such as PLA, the surface becomes smooth and reflects light. Especially, material such as transparent PLA can strongly reflect light to specific direction. Moreover, if the filament is colored, the reflection rate becomes lower; however, if only the inner part of filament is colored, the printed object can be opaque or half-transparent but the reflection ratio can be remained to be high. By using filament (before extrusion) with transparent material on the surface and with opaque or half-transparent material inside and by using a print head that makes melted filament gradually thinner (for example, the inner surface of the head is tapered), the structure of extruded filament can be controlled to be as above. (This means that the above method add a control that aims the reflection described above.)

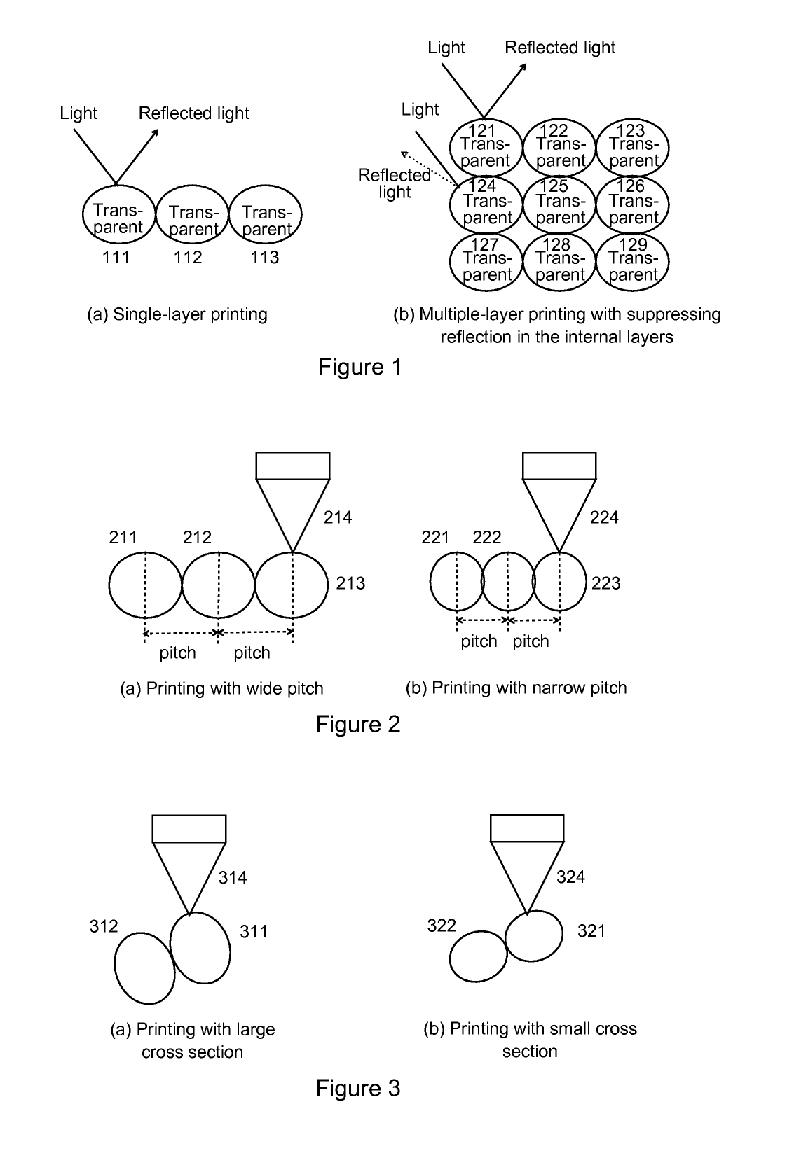

In conventional 3D printing methods, filaments are layered and stacked; however, to differentiate light reflection from direction to direction, it is effective to use only a single layer of filament (111, 112, and 113) as shown in FIG. 1(a). If layering multiple filament makes it difficult to uniform the reflection directions and tends to diffuse reflections, but the diffusion can be avoided by a single-layer structure. In addition, if a multiple-layer filament is used, as shown in FIG. 1(b), the surface filaments 121, 122, and 123 are made to be more reflective and the inner layers of filaments 124, 125, 126, 127, 128, and 129 are made of material without reflection, colored material, or opaque or half-transparent material, and the direction of strong reflection can be uniformed (can be the same direction).

The following methods can be used for controlling brilliance (i.e., can add a control that aims to give brilliance) by such reflecting light. The first method is to differentiate the interval of filament from location to location on the 3D printed object. FIG. 2(a) shows an object with a cross section close to a circle and diffusing light because the pitch of the filament 211, 212, and 213, which are extruded from the nozzle 214, are wide. In contrast, FIG. 2(b) shows an object with plane surface and easy to reflect light to the direction orthogonal to the surface because the pitch of the filament 221, 222, and 223, which are extruded from the nozzle 224, are narrow similar to FIG. 1(b). However, to contrast the difference of reflecting light among the locations on the 3D printed object, the change of pitch should be gradual and the pitches close should be nearly equal.

The second method is to vary the cross section of filament (i.e., adds a control that aims to vary the cross section) from location to location on the 3D printed object. FIG. 3(a) shows an object that reflects light to the direction orthogonal to the direction of the filament because the cross section of the filament 311 and 312, which are extruded from the nozzle 314, is large. In contrast, FIG. 3(b) shows an object that diffuses light in a similar way to FIG. 1(a). To differentiate the cross section from location to location, the printing velocity (i.e., the nozzle motion velocity while printing) or the filament extrusion velocity should be differentiated. If the nozzle motion velocity becomes larger or the filament extrusion velocity becomes smaller then the cross section reduces, and, on the contrary, if the nozzle motion velocity becomes smaller or the filament extrusion velocity becomes larger then the cross section increases. In this case, to contrast the difference of reflecting light among the locations on the 3D printed object, the change of cross section should be gradual; that is, the cross sections of neighbor filaments should be nearly equal. In addition, another method for controlling the cross section is to control both the height and width instead of directly controlling it.

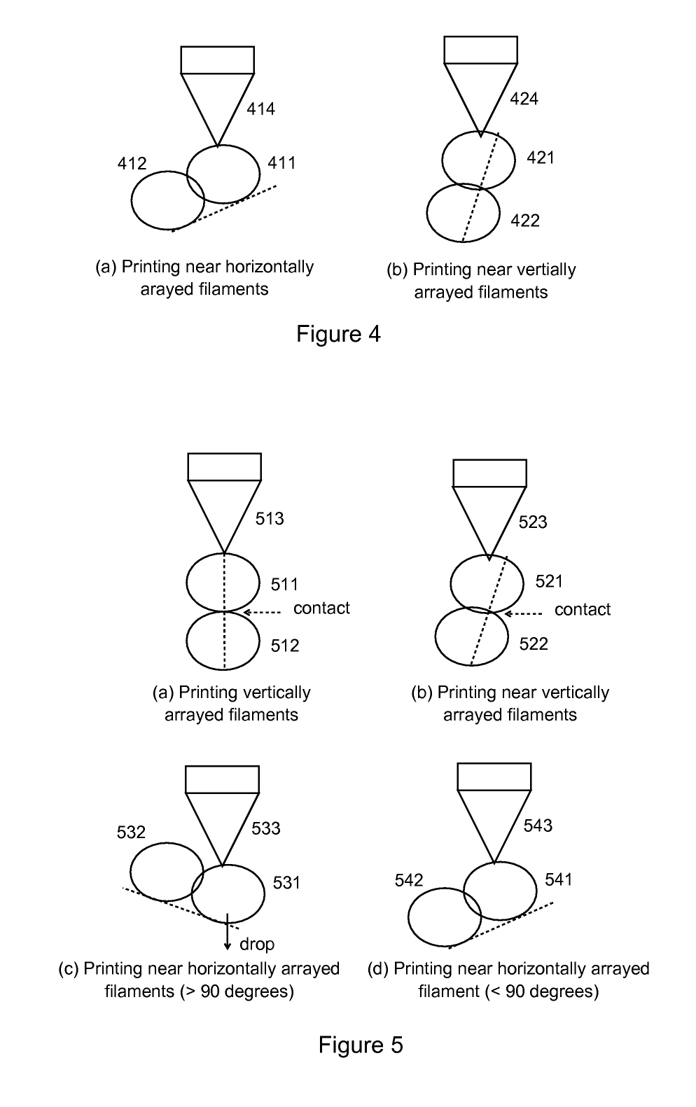

The third method is to vary the angle between neighboring filament (i.e., adds a control that aims to vary the angle). FIG. 4(a) shows an object that reflects light to the direction orthogonal to the direction of the filament because the filaments 411 and 412 are arrayed along a direction close to a horizontal direction. In contrast, FIG. 4(b) shows an object that reflects light to the direction parallel to the direction of the filament because the filaments 421 and 422 are arrayed along a direction close to the vertical direction. In this case, to contrast the difference of reflecting light among the locations on the 3D printed object (i.e., to make larger neighborhoods), the difference of directions should be gradual and the angles close should be nearly equal.

### [Conditions to be 3D-Printable]

The conditions of 3D printability (i.e., the set of conditions that makes 3D printing possible) are the following two. The first condition is that previously printed filaments do not prevent the printing process. If there is filament between the nozzle of the print head and the location to be placed melted filament, the printing fails. The second condition is that a printed filament must be supported so that it remains to stay in the designed (placed) location. The supporter may be either the print bed, the previously printed filament, or support material (which is material used only for supporting filaments and to be removed after printing). The filament is not necessarily supported from underneath, but it can be supported (from oblique or horizontal direction) if it is pressed to a supporter in a horizontal (or oblique) direction. If extruded filament is placed at a location where the filament does not contact with any supporter, the filament goes out of the placed location and moves to a downward or horizontally out-of-place location. To be 3D-printable, both of these conditions must be satisfied.

### [Method for Preserving 3D-Printability]

A method for preserving 3D-printability is explained using FIG. 5. When the direction of arraying (stacking) filaments is vertical, an upper filament 511 is pressed to a lower filament 512 so they are bonded. Because the shape of filament immediately after extrusion is close to a circle, by pressing and contacting to the neighbor filament, the shapes of filament 511 and 512 become closer to an ellipses. The lower end of the triangle 513 shows the location of the nozzle.

When the direction of arraying filaments is close to the vertical direction (as shown in FIG. 5(b)), the relationships between the filament 521 and 522 are mostly the same as the previously explained case, i.e., vertical case. So there will be no problem in this 3D printing. However, when the direction of arraying filaments are close to a horizontal direction and the angle between the centers of the filaments is negative, that is, if a filament printed later is placed obliquely downward (FIG. 5(c)), the filaments 531 and 532 are not easily bonded because the order is opposite to normal cases, so it is difficult to form the correct shape without reversing the print order. Even when the angle of neighboring filaments are positive (FIG. 5(d)), if the angle is small (i.e., close to horizontal), a problem that excess filament may wave or the upper filament may easily be dropped off without contacting to the lower filament occurs. In addition, even if neighboring filaments are contacted but not pressed, they might cause a problem that they are not bonded.

To solve the above problem, one of the following three methods can be applied. First, if the angle between the centers of the filaments are positive, the following methods can be applied and the object may become 3D-printable. That is, the cross section is adjusted (that is, these methods add a control that aim to adjust the cross section) and the upper and the lower filaments is contacted by applying one of these methods. There are three methods to increase the cross section. The first method is to increase the filament extrusion velocity. Unfortunately, if the filament extrusion velocity is increased, the filament may be waved or bended and it might not contacted to the neighbor filament. So two more alternative methods can be available. The second method for increasing the cross section is that, instead of increasing the extrusion amount, the cross section is increased by decreasing the nozzle motion velocity. By using this method, it becomes possible to increase the cross section without changing the filament extrusion velocity, it is effective when there is delay between the change of the extruder motion and the change of filament extrusion speed; that is, when the extrusion velocity is adjusted by the control system, the extrusion velocity does not immediately follows the control. However, although this method can reduce the waving of filament but it is difficult to eliminate the waving completely. The third method for increasing the cross section is that, by installing multiple nozzles (print heads) that have different inner diameters to the 3D printer, and the head with a larger nozzle is selected when printing with larger cross section and the head with a smaller nozzle is selected when printing with smaller cross section.

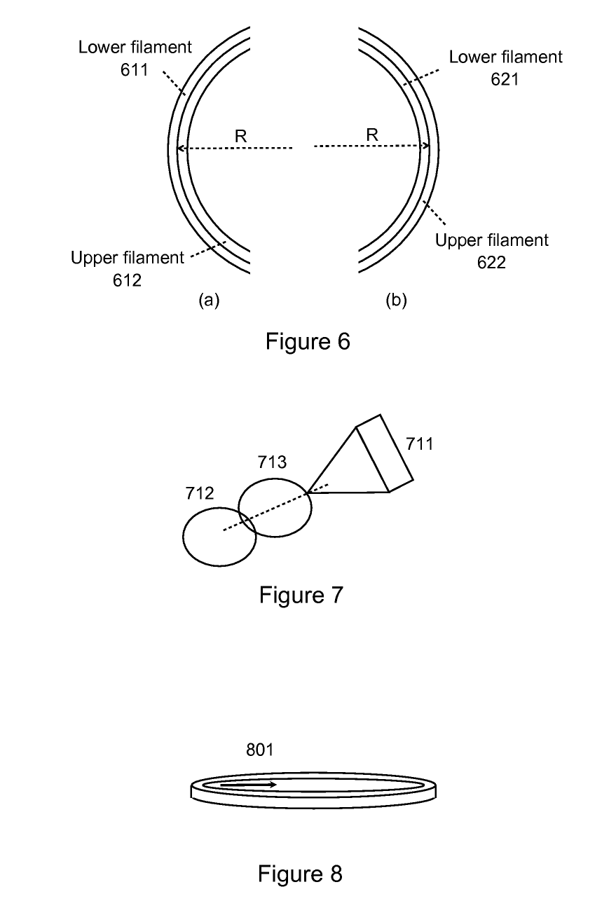

To solve the above problem, secondly, when the filament is arrayed close to a horizontal direction and the angle between the centers of the filaments is non negative, that is, a filament printed later is placed obliquely upward (or, including cases with small negative angle), the neighboring filaments are close to a horizontal direction as shown in FIG. 5(c) when printing, it is difficult to press and to bond the neighboring filaments. In this case, as shown in FIG. 6, the filaments can be bonded as follows.

The first case is explained by using FIG. 6(a). In FIG. 6(a), the lower filament 611 is on the left, and the upper filament 612 is on the right. The filament is assumed to bend to left, that is, the neighbor filament bends to the newly printed filament or the center of curvature radius is on the right, then the amount of filament is set to be slightly more than usual (excessive), i.e., the nozzle (print head) motion speed is slightly smaller compared with the filament extrusion speed. This makes the filament is pressed to the left and bonded. That is, the filament is pressed at the point that the extruded filament is solidified, so it is bonded. However, this process depends on the filament material, so the relationships between the filament extrusion speed and the nozzle motion speed must be dependent on the material.

The second case is explained by using FIG. 6(b). In FIG. 6(b), the lower filament 621 is on the left, and the upper filament 622 is on the right (as same as FIG. 6(a)). The filament is assumed to bend to right, that is, the neighbor filament bends to the opposite direction of the newly printed filament or the center of curvature radius is on the left, then the amount of filament is set to be slightly less than normal (lacked), i.e., the nozzle motion speed is slightly larger compared with the filament extrusion speed. This makes the filament is stretched and tensioned, pressed to the left, and bonded. That is, the filament is pressed at the point that the extruded filament is (partially or fully) solidified, so it is bonded to the (partially or fully) solidified filament. If the curvature of filament depends on locations, the amount of filament should be adjusted at each location according to the curvature. However, this process depends on the filament material, so the relationships between the filament extrusion speed and the nozzle motion speed must be dependent on the material.

As described above, it is difficult to preserve 3D-printability when the angle of the centers of filaments are negative, but it becomes printable if the order of printing is reversed, that is, if the direction and the order of filaments are reversed. If the filament is almost horizontal, they become printable by bonding filaments by using the method shown in FIG. 6 and explained above.

The method for preserving 3D-printability described above is applied when the print head extrude filament only to lower direction; however, if the print head can be rotated, a method described below can be applied. That is, as described in FIG. 7, by extruding filament to the direction of the line that connects the lower filament 712 and the upper filament 713 by rotating the print head 711, the filament 713 can be touched by the print head, so the filaments can be easily bonded together.

### [Bottom Surface Processing for Controlling Glaze]

According to the 3D printer and filament to be used, the surface of the print bed may have fine asperity that causes loosing transparency and glaze (i.e., reflection). For example, when using PLA for the print material, so-called blue tape, or masking tape used for painting, is often used to cover the print bed. The surface of this type of tape has fine asperity. In such a case, when printing the bottom of a dish or cup, if the 3D model is well designed so that only the initially printed part is contacted to the print bed and the successively printed parts do not contact it and are printed mostly horizontally, the printed filament can preserve the transparency and glaze. For example, in FIG. 8, one or more circles are printed on the print bed, and according to the printing method when the filament array is close to a horizontal direction, the bottom can be printed by drawing a spiral horizontally. That is, the print head moves in a spiral way and prints the bottom as a horizontal spiral. That is, to move the print head to the direction of the arrow drawn inside a circle (or a shape close to a circle) 801, and they draw the circle 801.

What are claimed are:

1. A method of 3D printing, which prints filaments and forms a 3D object by layering said filaments extruded by the print head of a 3D printer;
wherein the surface of extruded filament becomes polished and glazed;
comprising
a) first process of controlling extruding said filament approximately at regular intervals at each neighborhood in said 3D object,
b) second process of controlling the cross sections of said extruded filament at each neighborhood so that they become approximately the same, and
c) third process of controlling the angles between neighboring extruded filaments at each neighborhood so that they are approximately the same;
wherein said first, second, and third processes cause each neighborhood in said 3D object strongly reflects light to a certain direction depending on said neighborhood.

2. A method of 3D printing according to claim 1;
wherein extruded filament is layered to form multiple layers;
further comprising
e) fourth process of controlling to reflect light at the first filament of the surface layer, and
f) fifth process of controlling to suppress the reflection of light at the second filament of the inner layers;
wherein said fourth and fifth processes cause that each neighborhood in said 3D object strongly reflects light to a certain direction depending on said neighborhood.

3. A method of 3D printing according to claim 1;
further comprising fourth process of controlling to differentiate the intervals of filaments among said neighborhoods;
wherein said fourth process causes that the direction or strength of reflected light is varied in each neighborhood in said 3D object.

4. A method of 3D printing according to claim 1;
further comprising fourth process of controlling to differentiate the cross sections of filaments among said neighborhoods;
wherein said fourth process causes that the direction or strength of reflected light is varied in each neighborhood in said 3D object.

5. A method of 3D printing according to claim 4; wherein
said fourth process controls to vary the motion velocity of said nozzle;
wherein said fourth process causes that said cross sections are varied among said neighborhoods.

6. A method of 3D printing according to claim 4; wherein
said fourth process controls to vary the filament extrusion velocity among said neighborhoods;
wherein said fourth process causes that said cross sections are varied among said neighborhoods.

7. A method of 3D printing according to claim 4; wherein
a) multiple print heads with nozzles of different inner-diameters are preinstalled, and
b) said fourth process selects and uses one of said print heads with nozzle with larger inner-diameters;
wherein said fourth process causes that said cross sections are increased in certain said neighborhood.

8. A method of 3D printing according to claim 1;
said fourth process controls to vary the angle between neighboring filaments among said each neighborhood;
wherein said fourth process causes that the direction or strength of reflected light is varied in each neighborhood in said 3D object.

9. A method of 3D printing according to claim 1;
when said extruded filament is not supported from beneath;
further comprising a process of controlling the relationships of the extrusion velocity of said extruded filament and the motion velocity of said nozzle,
which causes that contacting and bonding said extruded filament and said neighboring filament.

10. A method of 3D printing according to claim 9; wherein
said extruded filament and said neighboring filament are located mostly in the same horizontal plane, and
said neighboring filament is supported from underneath;
further comprising a process of
wherein said extruded filament is supported by said neighboring filament and said extruded filament forms the bottom of said 3D object.

11. A 3D object, which consists of filaments that are extruded by the nozzle of a 3D printer;
wherein
a) the material of said filaments has polished and glazed surface,
b) the intervals of said filaments at each neighborhood in said 3D object are approximately the same,
c) the cross sections of said filaments at each neighborhood in said 3D object are approximately the same, and
d) the angles between neighboring extruded filaments at each neighborhood in said 3D object are approximately the same.

12. A 3D object according to claim 11;
wherein said 3D object consists of a single-layer filament.

13. A 3D object according to claim 11;
wherein said 3D object consists of multiple-layer filaments and
a) the surface layer reflects light at the surface and
b) the inner layers reflects less reflection.

14. A 3D object according to claim 11; wherein
transparent filament is used for said filament.

15. A 3D object according to claim 11;
wherein the interval between said filament and the neighboring filament varies location to location on said 3D object, and
the direction and strength of reflection depends on the location.

16. A 3D object according to claim 11;
wherein the cross section of said filament varies location to location on said 3D object, and
the direction and strength of reflection depends on the location.

17. A 3D object according to claim 11;
wherein the angle between said extruded filament and the neighboring filament varies location to location, and
the direction and strength of reflection depends on the location.
